(19) United States
(12) Patent Application Publication
(10) Pub. No.: US 2017/0308871 A1
(43) Pub. Date: Oct. 26, 2017

(54) WASTE BIN PLATFORM, WASTE MANAGEMENT SYSTEM AND METHOD FOR MANAGING WASTE

(71) Applicant: Joseph Edward Tallis, Nepean (CA)

(72) Inventor: Joseph Edward Tallis, Nepean (CA)

(21) Appl. No.: 15/185,525

(22) Filed: Jun. 17, 2016

(30) Foreign Application Priority Data
Apr. 26, 2016 (CA) 2928220

(51) Int. Cl. G06Q 10/00; G05B 15/02

(52) U.S. Cl. CPC G06Q 10/30; G05B 15/02

(57) ABSTRACT

A material handling system comprises a bin for holding material. The bin can be removably received within a bin platform that is able to measure a weight of the bin. The bin platform further comprises an electronically controlled covering that is opened to allow material to be placed into the bin, and closed when no further material is to be placed into the bin. The covering can be opened when an account is received, allowing the additional weight of material added to the bin to be associated with the received account.

### TECHNICAL FIELD

The current disclosure relates to platforms for waste bins and in particular to platforms that self-weigh the contents of waste bins.

### BACKGROUND

Waste generated at a site, such as a construction site, public garbage depot, condominium and apartment building, may be collected in waste bins. The waste bins may be relatively simple containers for holding the refuse. The waste bins may be collected from the site and transported to a location, such as a garbage dump, for disposal. The empty waste bin may be returned to the site or another waste bin may be returned in its place. Waste bins may include electronic scales in order to electronically track an amount of refuse added to the waste bin. The electronic waste bins may also associate added amounts of refuse with an account.

An additional, alternative, and/or improved waste bin management system is desirable.

### BRIEF DESCRIPTION OF THE DRAWINGS

Embodiments are described herein with reference to the appended drawings, in which:

FIG. 1 depicts a side view of a waste management system;

FIG. 2 depicts a perspective view of a waste bin platform enclosure;

FIGS. 3A and 3B depict illustrative user interfaces for the waste management system;

FIGS. 4A and 4B depict side views of a further waste management system; and

FIG. 5 depicts a method for managing waste.

### DETAILED DESCRIPTION

In accordance with the present disclosure there is provided a material handling system comprising a bin for receiving material, and a bin platform. The bin platform comprises: a platform enclosure for removably receiving the bin; at least one load cell for determining a weight on the platform enclosure; an electronically controllable covering positionable between an open position in which at least a portion of the bin, when received within the platform enclosure, is exposed to allow refuse to be placed in the bin, and a closed position in which the bin, when received within the platform enclosure, is substantially covered to prevent refuse from being placed in the bin; an electronic input component for receiving an identifier; and, a processing unit in communication with the electronic input component, the at least one load cell and the electronically controllable covering, the processing unit configured to receive the identifier from the electronic input component and determine if a valid account is associated with the identifier, and when it is determined that a valid account is associated with the identifier control the electronically controllable covering to allow moving to the open position, determine an amount of weight added to the bin when the bin is present in the platform enclosure and associate the weight added to the bin with the determined account.

In accordance with a further aspect of the material handling system, the electronic input component is located at the bin platform and comprises one or more of: a card reader; a keyboard; a keypad; a wireless communication radio; and a contactless tag reader.

In accordance with a further aspect of the material handling system, the wireless communication radio comprises a short range Bluetooth wireless communication radio.

In accordance with a further aspect of the material handling system, the platform enclosure comprises a base on which the at least one load cell is located.

In accordance with a further aspect of the material handling system, the platform enclosure comprises a plate located over the at least one load cell.

In accordance with a further aspect of the material handling system, the platform enclosure comprises a plurality of side walls.

In accordance with a further aspect of the material handling system, the platform enclosure comprises three side walls and an opening through which the bin may be inserted or removed.

In accordance with a further aspect of the material handling system, the platform enclosure further comprises a moveable wall for covering the opening through which the bin may be inserted or removed.

In accordance with a further aspect of the material handling system, the electronically controllable covering is attached to a top side of the plurality of side walls.

In accordance with a further aspect of the material handling system, the electronically controllable covering comprises: a moveable covering; and an electronically controllable lock capable of locking the electronically controllable covering to maintain the moveable covering in the closed position, or unlocking the electronically controllable covering to allow moving of the moveable covering to the open position.

In accordance with a further aspect of the material handling system, the moveable covering is manually operated.

In accordance with a further aspect of the material handling system, the moveable covering is operated by a motor or an actuator.

In accordance with a further aspect of the material handling system, the electronically controllable covering comprises: a moveable covering; and an electronically controllable motor or actuator capable of securing the moveable covering in the closed position or moving the moveable covering to the open position.

In accordance with a further aspect of the material handling system, the moveable covering is one of: a sliding cover; a rolling cover; and a hinged cover.

In accordance with a further aspect of the material handling system, further comprising a mobile device for communicating with the processing unit and providing the identifier to the processing unit via the electronic input component.

In accordance with a further aspect of the material handling system, the mobile device communicates with the processing unit using wireless communication.

In accordance with a further aspect of the material handling system, further comprising a server communicatively coupled to the processing unit for receiving account information and usage information including the amount of weight added to the bin.

In accordance with a further aspect of the material handling system, the processing unit is located at the bin platform.

In accordance with a further aspect of the material handling system, the processing unit is located at a remote server.

In accordance with a further aspect of the material handling system, the identifier comprises one or both of an account identifier and a bin identifier.

In accordance with a further aspect of the material handling system, the bin is an open-top bin sized between 10 and 40 yards.

In accordance with the present disclosure there is also provided a bin platform comprising: a platform enclosure for removably receiving a bin; at least one load cell for determining a weight on the platform enclosure; an electronically controllable covering positionable between an open position in which at least a portion of the bin, when received within the platform enclosure, is exposed to allow refuse to be placed in the bin, and a closed position in which the bin, when received within the platform enclosure, is substantially covered to prevent refuse from being placed in the bin; an electronic input component for receiving an identifier; and, a processing unit in communication with the electronic input component, the at least one load cell and the electronically controllable covering, the processing unit configured to receive the identifier from the electronic input component and determine if a valid account is associated with the identifier, and when it is determined that a valid account is associated with the identifier control the electronically controllable covering to allow moving to the open position, determine an amount of weight added to the bin when the bin is present in the platform enclosure, and associate the weight added to the bin with the determined account.

In accordance with a further aspect of the bin platform, the electronic input component comprises one or more of: a card reader; a keyboard; a keypad; a wireless communication radio; and a contactless tag reader.

In accordance with a further aspect of the bin platform, the wireless communication radio comprises a short range Bluetooth wireless communication radio.

In accordance with a further aspect of the bin platform, the platform enclosure comprises a base on which the at least one load cell is located.

In accordance with a further aspect of the bin platform, the platform enclosure comprises a plate located over the at least one load cell.

In accordance with a further aspect of the bin platform, the platform enclosure comprises a plurality of side walls.

In accordance with a further aspect of the bin platform, the platform enclosure comprises three side walls and an opening through which the bin may be inserted or removed.

In accordance with a further aspect of the bin platform, the platform enclosure further comprises a moveable wall for covering the opening through which the bin may be inserted or removed.

In accordance with a further aspect of the bin platform, the electronically controllable covering is attached to a top side of the plurality of side walls.

In accordance with a further aspect of the bin platform, the electronically controllable covering comprises: a moveable covering; and an electronically controllable lock capable of locking the electronically controllable covering to maintain the moveable covering in the closed position or unlocking the electronically controllable covering to allow moving of the moveable covering to the open position.

In accordance with a further aspect of the bin platform, the moveable covering is manually operated.

In accordance with a further aspect of the bin platform, the moveable covering is operated by a motor or an actuator.

In accordance with a further aspect of the bin platform, the electronically controllable covering comprises: a moveable covering; and an electronically controllable motor or actuator capable of securing the moveable covering in the closed position or moving the moveable covering to the open position.

In accordance with a further aspect of the bin platform, the moveable covering is one of: a sliding cover; a rolling cover; and a hinged cover.

In accordance with a further aspect of the bin platform, the identifier comprises one or both of an account identifier and a bin identifier.

In accordance with the present disclosure there is also provided a method of managing waste disposal comprising: receiving a waste bin within a bin platform; receiving an identifier at the bin platform; determining if a valid account is associated with the identifier; if a valid account is associated with the identifier, opening a covering of the bin platform to allow waste to be deposited into the bin; closing the covering of the bin platform when depositing refuse to the bin is completed; associating with the account a weight of the refuse deposited to the bin; and, removing the bin from the bin platform when the bin is filled with refuse or the bin has reached a predetermined weight.

The waste management system disclosed herein provides a convenient system for metering an amount of refuse placed into a waste bin and associating the added waste to a particular user or account. Metering the amount of refuse added allows for billing a user for the waste generated and as such may provide an incentive for the user to reduce the amount of waste generated. Further, the waste management system works with roll off bins, or other waste bins, allowing easy integration of the waste management system into existing routines such as bin collection.

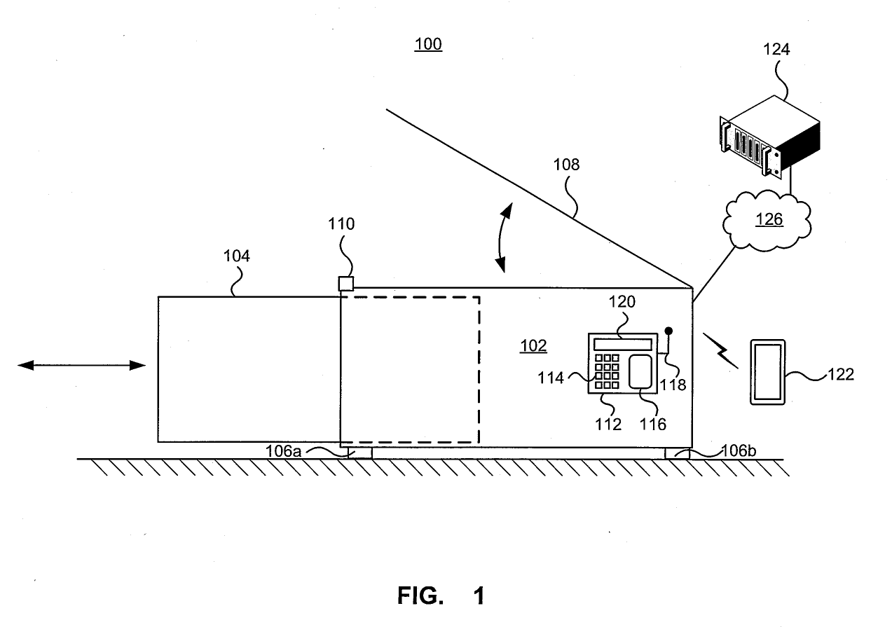

FIG. 1 depicts a waste management system. The waste management system 100 comprises a bin platform 102 that receives a bin 104. The bin platform 102 may have different sizes for accommodating different size waste bins. For example, different sizes of bin platforms may accommodate bin sizes from, for example, 10-40 yards. The bin 104 can be received within, and withdrawn from, the bin platform 102. When a bin 104 is full, or if the bin has reached a predetermined weight, it can be removed to be emptied. When the bin 104 is removed, the bin platform 102 remains in place and another bin can be placed in the platform 102. Accordingly, the waste management system 100 can use any bin that will fit within the bin platform 102.

The bin platform 102 comprises one or more load sensors 106a, 106b (referred to collectively as load sensors 106), which are depicted as being located at the corners of the bin platform 102. The load sensors 106 may be provided by load cells or other sensors capable of measuring a weight on the load sensor. The load sensors 106 are able to determine a weight of the bin 104 and its contents. The number and placement of load sensors 106 may vary depending upon the size of the bin platform and/or bin(s) to be placed in the platform. For example, four load sensors may be included such that there is one sensor at each corner of the platform, or eight sensors may be included such that sensors are located at platform corners and evenly spaced at other locations of the platform. Alternative amounts of load sensors and locations are possible as well.

The bin platform 102 provides an enclosure that at least partially encloses the bin 104 when it is received within the bin platform 102. The waste management system 100 includes an electronically controllable covering 108 that is positionable between an open position and a closed position. The electronically controllable covering 108 may include an electronic lock, depicted as box 110, which allows the covering to open or prevents the covering from opening. When unlocked, the positioning, such as the opening, of the electronically controllable covering 108 may be done manually, or may use a motor or other type of actuator. When the electronically controllable covering 108 is in the open position, at least a portion of the waste bin 104 within the bin platform 102 is exposed and accessible to allow refuse to be placed in the waste bin. When the electronically controllable covering 108 is in a closed position, the waste bin 104 is substantially covered to prevent refuse from being placed in the bin 104.

The bin platform 102 includes electronics 112 for controlling operation of the waste management system 100. The electronics 112 may be coupled to the load sensors 106 as well as the electronically controllable covering 108 and the electronic lock 110. The electronics 112 include at least one electronic input component for receiving an identifier. The electronic input components may include, for example, key pads 114 for entering the identifier, a contactless card reader, such as a radio frequency identifier (RFID) reader 116, a wireless radio, which at the electronics 112 may be depicted as antenna 118, or other electronic or wireless communication means or components. The wireless radio may comprise a Bluetooth radio, a Bluetooth low-energy tag or radio, a ZigBee radio, WiFi radio, or other types of wireless network communications. The electronics may include a display screen 120 for displaying information. The electronics 112 may communicate with one or more devices, such as a mobile device 122, or with one or more servers 124 through one or more networks 126.

When a user inputs an identifier, either manually or through communication with the mobile device 122 or servers 124, it may be determined whether the identifier is associated with an account. For example, the user may use key pads 114 to enter the identifier or otherwise communicate with the system. Alternatively, the user may use mobile device 122 (including any application thereon) to communicate directly with the antenna 18 to enter the identifier or otherwise communicate with the system. In the further alternative, the user may use mobile device 122 (including any application thereon) to communicate directly with one or more servers 124 through one or more networks 126 to enter the identifier or otherwise communicate with the system. In each of these example situations, the electronics 112 and/or the one or more servers 124 may separately or each comprise processing units and/or electronic input components, and be responsible for receiving, processing and/or determining whether an inputted identifier is associated with an account. Where the one or more servers 124 perform one or more of these functions, the one or more servers 124 may communicate the result(s) of its determination to the electronics 112 via the one or more networks 126. Additionally, the electronics 112 and/or the one or more servers 124 may also require inputting of a password for security purposes or in order to verify the user is an authorized user of the account.

If the identifier is associated with an account, the electronically controllable covering 108 can be opened, for example by unlocking the electronic lock 110, and then moving the covering 108 to the open position. With the covering 108 open, the electronics 112 can monitor the load sensors 106 in order to determine an amount of weight added to the bin 104. For example, prior to opening the covering 108 and/or the user adding any refuse to the bin, the electronics may determine a starting weight for the bin and its contents. Once the user has completed adding refuse to the bin, the total amount of weight added can be determined and associated with the particular account. Once using the bin is complete, the covering 108 may be closed and locked in order to prevent other individuals—particularly unauthorized individuals—from adding refuse to the bin. The total amount of weight added may be determined by subtracting the starting weight from a weight measured at the time that the user has completed adding refuse and/or when the covering 108 is closed. A user may communicate that it is finished with using the bin (i.e., “log out” from the waste management system) by communicating, either manually or through communication with the mobile device 122 or servers 124, with the electronics 112. Such communication may include re-inputting the identifier, terminating a communication connection with the electronics, and/or sending a message to the electronics that the user is finished (e.g., sending an instruction to close the bin). Alternatively, if a certain amount of time passes with no activity or inputting of refuse to the bin, the electronics 112 may automatically time-out the user's session, and automatically close the covering 108 and determine the total amount of weight added.

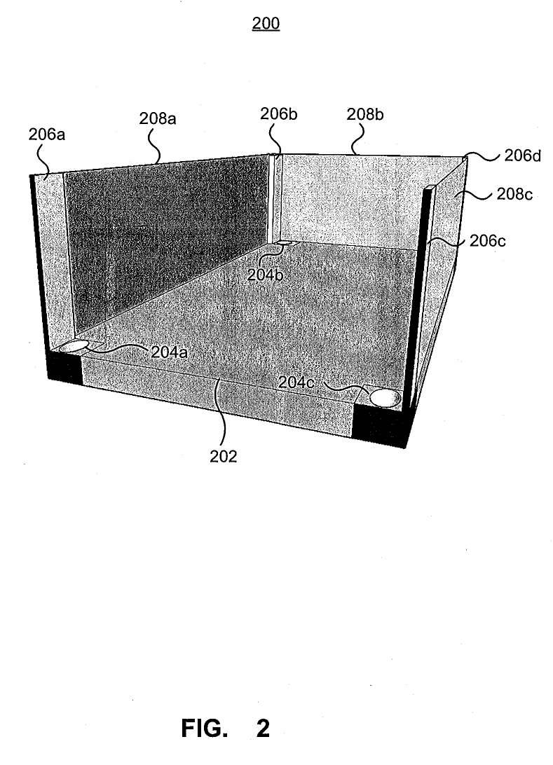

FIG. 2 depicts a waste bin platform enclosure. The platform enclosure 200 may be used as the platform 102 described above. The platform enclosure 200 can accommodate a standard roll off bin of varying sizes, such as 10 yard, 20 yard, 30 yard, or 40 yard. The platform 200 comprises a base platform 202. A number of load cells 204a, 204b, 204c, 204d (not shown) may be located or exposed at or on the upper surface of the base platform 202 at appropriate locations, such as at each of the corners. Reinforced steel pillars 206a, 206b, 206c, 206d may be located to provide strength to the enclosure as well as protect the load cells against the outside environment and blunt force damage. Steel plates 208a, 208b, 208c may provide side walls of the enclosure and provide a structure to which other components, including for example the covering (not shown), can be secured. As depicted, the platform may be a 3-sided enclosure. The open side may be used to insert and remove the bin from the platform. Alternatively, the enclosure may comprise a fourth side wall that can be opened, or removed, to allow bins to be inserted and removed from the platform, and that also can be closed, or re-attached, when the bin is within the enclosure. When the load cells 204 are located or exposed at or on the upper surface of the base platform 202, a further steel plate (not depicted), or multiple steel plates, may be located on top of the load cells 204 and may act as a supporting platform or surface for the roll off bin. The steel plate(s) would be positioned such that when the bin has been inserted into the platform, the load cells are able to accurately monitor the weight of the bin. In this regard, the steel plate(s) may simply be resting on the load cells and otherwise not be welded or permanently fixed to the platform enclosure in order for the load cells to accurately monitor the weight of the bin. Alternatively, the base platform 202, which may also be made of steel, may itself act as a supporting platform or surface for the roll off bin, preferably if the load cells 204 are located just below the base platform 202 where they are not exposed to a roll off bin or vulnerable to damage (blunt force or otherwise). Under this alternative configuration, the base platform 202 would be configured or positioned such that when the bin has been inserted into the platform, the load cells are able to accurately monitor the weight of the bin. This may require that the base platform 202 rest on the load cells and otherwise not be welded or permanently fixed to the platform enclosure in order for the load cells to accurately monitor the weight of the bin.

As described above, a waste management system comprises a platform enclosure that can receive a bin. The platform enclosure includes a covering that can be electronically opened, or unlocked, and closed, or locked. The opening and closing of the covering may be controlled so that the covering is opened when an account is received and closed when the bin is determined to no longer be in use. When the bin is open, the added weight is monitored and associated with the account used to open the bin. The account may be billed based on the amount of weight added. The account may include payment information, such as credit card information, in order to allow automatic payment of the fees. A cloud-based billing system may be used to carry out such automatic billing and payment. Alternatively, the system may, on a monthly or other periodic basis, send invoices or statements of account to users via mail, e-mail or other means so that they are prompted to make payment. The bin platform may communicate with one or more servers through a wired or wireless network, and the servers may provide various functionality such as account creation and management, payment, etc. Additionally, the servers may communicate with the bin platform in order to control it, such as opening or closing the covering. Users may enter identifiers, which may be an account identifier and/or a bin identifier, and/or may use a mobile device and associated application to unlock, or open the bin platform. For example, a user may enter an account identifier into a key pad at the bin platform, or on the user's mobile device for further communication by the mobile device with the electronics of the bin platform and/or remote servers. Alternatively, the user may enter a bin identifier on the user's mobile device for further communication by the mobile device with the electronics of the bin platform and/or remote servers in association with the user's account information. The bin identifier may be displayed on the bin platform or nearby so that a user may know which specific bin identifier to enter or submit.

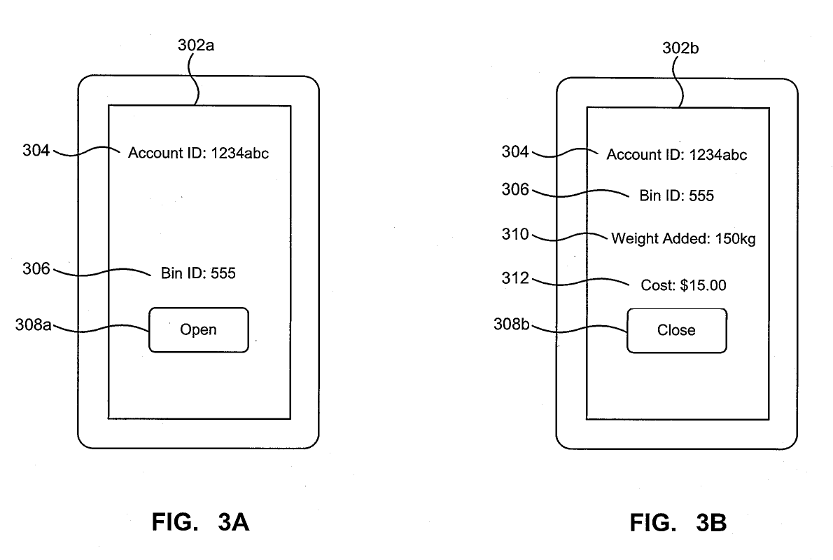

FIGS. 3A and 3B depict illustrative user interfaces for the waste management system. FIG. 3A depicts an illustrative user interface screen 302a that may be presented on a mobile device, such as mobile device 122 described above with reference to FIG. 1, when the mobile device is in communication with the bin platform. It will be appreciated that the user interface screen 302a is intended only as an example, and a large number user interfaces that provide the same or similar functionality are possible. The user interface screen 302a may include an account identifier 304. The account identifier 304 may be stored on the mobile device and may be changed by the user. As depicted, when the mobile device is in communication with a bin platform, for example using Bluetooth communication, the bin platform may provide a bin identifier 306 to the mobile device and the bin identifier may be displayed. Although not depicted, the user interface screen 302a may display additional information regarding the bin, such as types of refuse that are accepted, costs for using it, etc. The user interface screen 302a may include a button 308a that allows the user to open the bin platform in order to add refuse to the bin. When the user wants to open the bin platform, for example by pressing the open button 308a, the mobile device may send an open command to the bin identifying the account identifier. Communication of the open command may be the initial or only communication from the user to trigger opening of the bin platform.

FIG. 3B depicts a user interface screen 302b on the mobile device when the bin platform is in use. As depicted, in addition to the account identifier 304 and bin identifier 306, the amount of weight added 310 to the bin along with the cost 312 for the added refuse may be displayed. As refuse is added to the bin, the amount of weight 310 and the cost 312 may be updated by the waste management system in real-time by regularly or periodically measuring the contents of the bin platform. Alternatively, the amount of weight 310 and the cost 312 may only be displayed after a user is finished adding refuse or the bin platform has been closed. With respect to closure, the user interface screen 302b may include a button 308b for sending a close command to the bin platform to have it closed. Communication of the close command may be the final or only communication from the user to trigger closing of the bin platform, and/or subsequent actions by the waste management system, such as issuing a bill to the user, sending an e-mail to the user reporting the transaction or otherwise updating one or more records associated with the system or user. Additional information, such as date and time of the transaction, and geographical location or street address, may also be displayed on one or both of user interface screen 302a and 302b.

The waste management system described above depicts a hinged electronically controllable covering that may be electronically unlocked and manually lifted into an open position. Different electronically controllable coverings are possible, such as roll off coverings that may roll up, or panel-style or other coverings that may slide. The coverings may be operated (e.g., moved between open and closed) manually or automatically using a motor or other actuators. Operation of the coverings may involve hinging, rolling and/or sliding of the coverings.

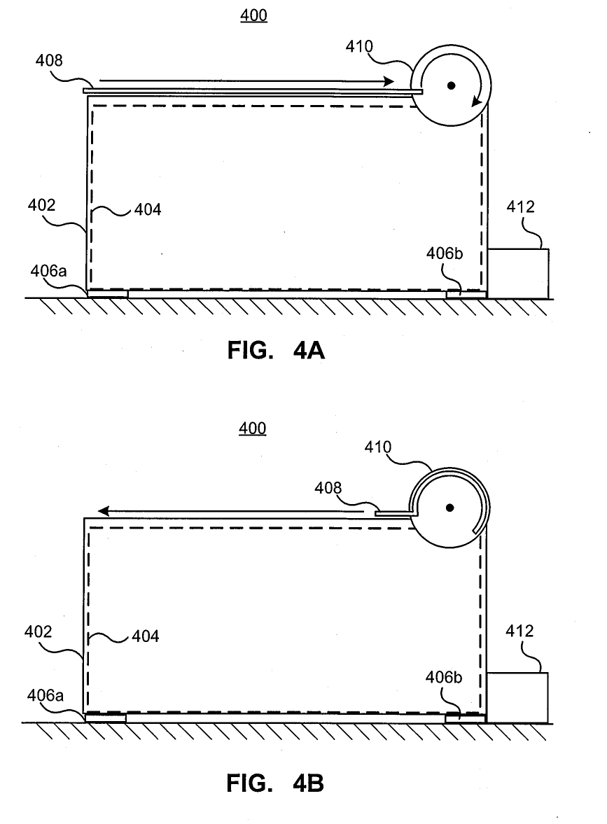

FIGS. 4A and 4B depict a further waste management system. FIG. 4A depicts waste management system 400 in a closed position. FIG. 4B depicts the waste management system 400 in an open position. The waste management system 400 comprises a bin platform 402 that at least partially encloses a bin 404 for holding material such as garbage. The platform 402 includes a plurality of load sensors 406a, 406b for determining an amount of weigh on the platform, including in particular in the bin 404. A covering 408 may be electronically controlled in order to move between the closed position of FIG. 4A and the open position of FIG. 4B. The covering 408 may be rolled in a roller 410 that is controlled by electronics 412 of the bin platform 402. The electronics 412 can open the covering 408, either by unlocking the roller 410 to allow a user to manually roll the cover open or by operating a motor for the roller 410 for automatically moving the cover 408. Once the use of the bin has been completed, the covering can be closed, either manually by a user, or automatically through a motor, and locked in the closed position.

The bin platforms described above have depicted a covering that covers a top of the bin platforms and that may open and close. It is contemplated that the covering may only cover an opening in an otherwise enclosed top, or an opening on or more of the side walls. The covering can be controlled electronically to allow the covering to be opened when an account identifier is received, for example by Bluetooth communication or manually entered. When the bin is unlocked as a result of receiving an account identifier, the amount of material added to the bin can be determined and the weight associated with the account.

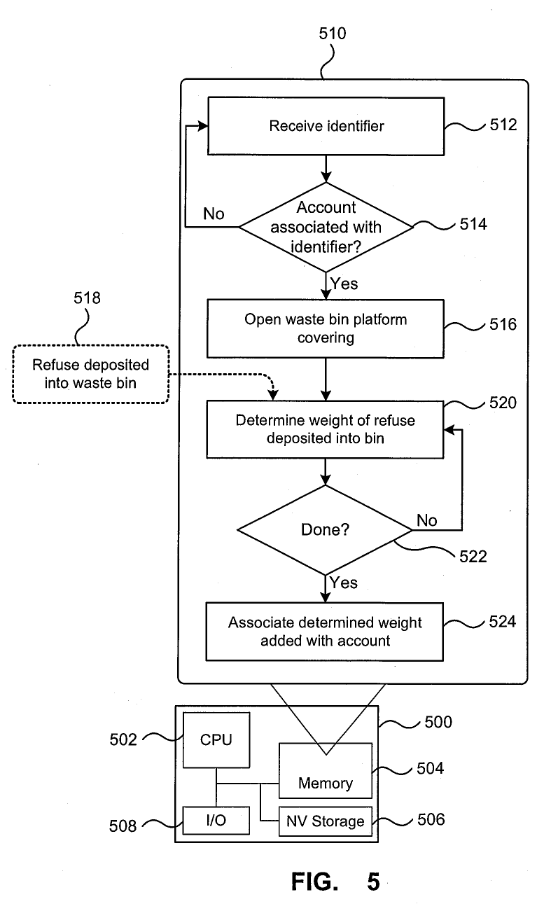

FIG. 5 depicts a method for managing waste. As depicted, the method 510 may be implemented by electronics 500. The electronics 500 may include a central processing unit (CPU) 502 for executing instructions and a memory unit 504 for storing instructions. The electronics 500 may further comprise long-term or non-volatile (NV) storage 506 such as a hard drive, or flash memory. Further, one or more I/O interfaces 508 may be included in order to couple other devices, such as input components, including Bluetooth and/or other wireless radios. The I/O interfaces 508 may also include interfaces for coupling with the electronically controllable covering.

The instructions stored in the memory unit 504 include instructions that when executed by the processing unit 502 configure the electronics 500 to provide a method for managing waste 510. The method receives an identifier (512). The identifier may be received over a Bluetooth connection, from a keyboard or keypad input, using a contactless card or tag reader, or from communicating over a network with an external device such as a server that has received an identifier from a user's mobile or other device or application. The identifier is checked to determine if it is associated with an account (514). Checking of the identifier may be done at or by the electronics 500, or at or by an external device that is able to communicate with the electronics 500. Although described as being separate from an account, it is possible for the identifier to be an account identifier or account number. Inputting of a password for security purposes or in order to verify the user is an authorized user of the account may also be required. If there is no associated account (No at 514), or if the account is not valid for other reasons such as failure to make payment or invalid password, the processing returns to receive an identifier. The user may be informed of the error and may attempt entering the account information again. If there is an account (Yes at 514), the covering of the bin platform is opened (516). Opening the cover may simply involve unlocking an electronic lock so that a user can manually open the cover. Additionally or alternatively, the opening may use an actuator or motor to open the covering without intervention by the user. With the cover open a user may begin placing material into the bin (518). The weight of the material may be monitored (520). It can be determined if the user is done adding material to the bin (522). The determination of whether or not adding material is finished may be accomplished in a number of ways. For example, the user may actively signal they are done by closing the covering, pressing a button, or leaving the vicinity if Bluetooth communication is used. Leaving the vicinity will result in the Bluetooth connection failing which can be used as a signal that the user is done. Additionally or alternatively, the amount of weight added may be monitored and if it has not changed for a threshold amount of time (e.g., session time-out), it can be assumed that no more material is going to be added. If it is determined that the user is not done adding material (No at 522), the user can continue adding material and the weight monitored (520). If it is determined that the user is done adding material (Yes at 522), the added weight can be associated with the user's account (524) used in opening the covering. The amount of weight added may be determined by comparing a weight of the bin before opening the covering to the weight once the user is done. Associating the added weight with the account may also include associating a cost associated with disposing of the material. The account may be associated with one or more payment accounts, and/or payment information such as credit card account information, for paying the cost for disposing of the material.

The bin platform described above may be used in a number of different applications. For example, construction sites have a number of different trades on-site that dispose of a significant amount of waste. Building the cost of waste disposal into contracts for the different trades, and billing individual trades for an amount of waste generated can be inefficient, result in inaccuracies and be difficult to do. The waste management system of the present disclosure can eliminate, or at least mitigate, these inadequacies. Each trade person can be given an account identifier allowing the waste generated and deposited into bins to be easily and accurately tracked and billed, if desired. Further, if trades are billed for the amount of waste generated, it may encourage trades people to reduce the amount of waste generated and/or thrown away.

A further application of the presently disclosed waste management system is in condominiums, apartments and/or commercial buildings. Such buildings may be home to a diverse group of both companies and people. Garbage companies often charge to remove a building's waste as a whole, and the associated cost may be billed back to all users equally regardless of waste produced or contributed by an individual user. In contrast, use of the presently disclosed waste management system can allow the waste associated with individual users, owners or tenants to be tracked, and associated costs to be charged back on a proportional or weight-dependent basis if desired.

The waste management system may also be conveniently used at municipal dump sites. The waste management system may be used to allow individuals to dispose of material while being billed based on the amount (weight) of waste disposed.

The waste management system described above allows material placed into bins to be tracked and associated with a user or account. Further, the waste management system comprises a stationary bin platform that removably receives a waste bin. The waste bin can be removed when full and replaced with an empty bin. Conveniently, the waste management system does not require that the waste bin be mechanically or electrically connected or joined to the bin platform or electronics of the system. In this regard, the system only requires that the waste bin be inserted into the bin platform so that the weight of the bin and its contents may be monitored. By leaving the bin platform with sensors and electronics together and in one place, it allows one or multiple standard low cost waste bins to be used and reused, and therefore fewer bin platforms overall would be needed. Further, it can reduce an amount of times the bin platforms themselves are moved from one location to another, which in turn can reduce the likelihood of damage to the electronics and sensors, or disruption to any calibrated components. The bin platform of the present disclosure may be left unattended such that a user alone may interact with the waste management system. As a result of the locked or otherwise secured covering that may be in place when a user is not using the system, non-users may be prevented from using the system or adding waste to the waste bin even if the system is unattended.

The waste management system provides a convenient system for handling material such as waste materials. Although described above as primarily a waste management system, it will be appreciated that the same system can readily be applied to handling other materials.

The present disclosure provided, for the purposes of explanation, numerous specific embodiments, implementations, examples and details in order to provide a thorough understanding of the invention. It is apparent, however, that the embodiments may be practiced without all of the specific details or with an equivalent arrangement. In other instances, some well-known structures and devices are shown in block diagram form, or omitted, in order to avoid unnecessarily obscuring the embodiments of the invention. The description should in no way be limited to the illustrative implementations, drawings, and techniques illustrated, including the exemplary designs and implementations illustrated and described herein, but may be modified within the scope of the appended claims along with their full scope of equivalents.

While several embodiments have been provided in the present disclosure, it should be understood that the disclosed systems and components might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A material handling system comprising:
a bin for receiving material;
a bin platform comprising:
a platform enclosure for removably receiving the bin;
at least one load cell for determining a weight on the platform enclosure;
an electronically controllable covering positionable between:
an open position in which at least a portion of the bin, when received within the platform enclosure, is exposed to allow refuse to be placed in the bin; and
a closed position in which the bin, when received within the platform enclosure, is substantially covered to prevent refuse from being placed in the bin;
an electronic input component for receiving an identifier; and
a processing unit in communication with the electronic input component, the at least one load cell and the electronically controllable covering, the processing unit configured to:
receive the identifier from the electronic input component and determine if a valid account is associated with the identifier; and
when it is determined that a valid account is associated with the identifier:
control the electronically controllable covering to allow moving to the open position;
determine an amount of weight added to the bin when the bin is present in the platform enclosure; and
associate the weight added to the bin with the determined account.

2. The material handling system of claim 1, wherein the electronic input component is located at the bin platform and comprises one or more of:
a card reader;
a keyboard;
a keypad;
a wireless communication radio; and
a contactless tag reader.

3. The material handling system of claim 2, wherein the wireless communication radio comprises a short range Bluetooth wireless communication radio.

4. The material handling system of claim 1, wherein the platform enclosure comprises a base on which the at least one load cell is located.

5. The material handling system of claim 4, wherein the platform enclosure comprises a plate located over the at least one load cell.

6. The material handling system of claim 1, wherein the platform enclosure comprises a plurality of side walls.

7. The material handling system of claim 1, wherein the electronically controllable covering comprises:
a moveable covering; and
an electronically controllable lock capable of locking the electronically controllable covering to maintain the moveable covering in the closed position, or unlocking the electronically controllable covering to allow moving of the moveable covering to the open position.

8. The material handling system of claim 1, wherein the electronically controllable covering comprises:
a moveable covering; and
an electronically controllable motor or actuator capable of securing the moveable covering in the closed position or moving the moveable covering to the open position.

9. The material handling system of claim 1, further comprising a server communicatively coupled to the processing unit for receiving account information and usage information including the amount of weight added to the bin.

10. The material handling system of claim 1, wherein the identifier comprises one or both of an account identifier and a bin identifier.

11. A bin platform comprising:
a platform enclosure for removably receiving a bin;
at least one load cell for determining a weight on the platform enclosure;
an electronically controllable covering positionable between:
an open position in which at least a portion of the bin, when received within the platform enclosure, is exposed to allow refuse to be placed in the bin; and
a closed position in which the bin, when received within the platform enclosure, is substantially covered to prevent refuse from being placed in the bin;
an electronic input component for receiving an identifier; and
a processing unit in communication with the electronic input component, the at least one load cell and the electronically controllable covering, the processing unit configured to:
receive the identifier from the electronic input component and determine if a valid account is associated with the identifier; and
when it is determined that a valid account is associated with the identifier:
control the electronically controllable covering to allow moving to the open position;
determine an amount of weight added to the bin when the bin is present in the platform enclosure; and
associate the weight added to the bin with the determined account.

12. The bin platform of claim 11, wherein the electronic input component comprises one or more of:
a card reader;
a keyboard;
a keypad;
a wireless communication radio; and
a contactless tag reader.

13. The bin platform of claim 12, wherein the wireless communication radio comprises a short range Bluetooth wireless communication radio.

14. The bin platform of claim 11, wherein the platform enclosure comprises a base on which the at least one load cell is located.

15. The bin platform of claim 14, wherein the platform enclosure comprises a plate located over the at least one load cell.

16. The bin platform of claim 11, wherein the platform enclosure comprises a plurality of side walls.

17. The bin platform of claim 11, wherein the electronically controllable covering comprises:
a moveable covering; and
an electronically controllable lock capable of locking the electronically controllable covering to maintain the moveable covering in the closed position or unlocking the electronically controllable covering to allow moving of the moveable covering to the open position.

18. The bin platform of claim 11, wherein the electronically controllable covering comprises:
a moveable covering; and
an electronically controllable motor or actuator capable of securing the moveable covering in the closed position or moving the moveable covering to the open position.

19. The bin platform of claim 11, wherein the identifier comprises one or both of an account identifier and a bin identifier.

20. A method of managing waste disposal comprising:
receiving a waste bin within a bin platform;
receiving an identifier at the bin platform;
determining if a valid account is associated with the identifier;
if a valid account is associated with the identifier, opening a covering of the bin platform to allow waste to be deposited into the bin;
closing the covering of the bin platform when depositing refuse to the bin is completed;
associating with the account a weight of the refuse deposited to the bin; and
removing the bin from the bin platform when the bin is filled with refuse or the bin has reached a predetermined weight.
